(19) United States
(12) Patent Application Publication
(10) Pub. No.: US 2015/0152785 A1
(43) Pub. Date: Jun. 4, 2015

(54) AIR INTAKE HOOD FOR TURBINE INLET FILTER HOUSE

(71) Applicant: BHA Altair, LLC, Franklin, TN (US)

(72) Inventors: Rajesh Prabhakaran Saraswathi, Bangalore (IN); Bradly Aaron Kippel, Greenville, SC (US); Jianmin Zhang, Greer, SC (US); Arun Eapen Mathew, Bangalore (IN)

(73) Assignee: BHA Altair, LLC, Franklin, TN (US)

(21) Appl. No.: 14/095,788

(22) Filed: Dec. 3, 2013

(51) Int. Cl. F02C 7/052; F02C 7/04

(52) U.S. Cl. CPC F02C 7/052; F02C 7/04

(57) ABSTRACT

An air intake hood for channeling an incoming air flow downward in a filter house. The intake hood includes an inlet that is inclined.

### BACKGROUND OF THE INVENTION

The subject matter disclosed herein relates to filter house air filtration, in particular, to an improved intake hood.

Gas turbines include inlet air treatment systems that remove moisture and dust from air that is channeled to the compressor. Some inlet air treatment systems include moisture separators and coalescing pads that remove moisture from intake air, and final filters that remove dust and debris. During normal operating conditions, it is desired to have the inlet air treatment system channel the dehydrated and filtered air to the compressor with minimal airflow disruption and air pressure drop. Clogged air filters reduce the efficiency of the gas turbine and typically have to be pressure pulsed periodically to dislodge dust and debris which drops away from the air filters to the bottom of the filter house where a collection mechanism is employed to remove the debris.

In order to efficiently clean the filters, the air flow through the filter house inlet area desirably generate a sufficient down flow of intake air so that the dust and debris makes its way to the bottom of the filter house. Incoming air flow in typical intake hoods travels through a path requiring greater distortion in the air flow and causing unnecessary turbulence as it entered a filter house. This is because the intake hoods were typically positioned with their openings parallel to the ground. A poor air flow pattern creates non-uniform air velocities and recirculation pockets at the inlet area resulting in the dust and debris being sucked back into the filters soon after the pulsed cleaning is performed. Accordingly, it is desirable to provide an air filtration system having an improved air flow pattern that optimizes operation of the cleaning cycles.

The discussion above is merely provided for general background information and is not intended to be used as an aid in determining the scope of the claimed subject matter.

### BRIEF DESCRIPTION OF THE INVENTION

This specification describes an apparatus for improving the down flow effect of intake air and reducing recirculation zones in a gas turbine air intake system. An air intake hood for channeling an incoming air flow downward in a filter house is disclosed. The intake hood includes an opening, or inlet, that is inclined. An advantage that may be realized in the practice of some disclosed embodiments of the intake hoods is reduced clogging in pulse filters, improved cleaning effectiveness of pulse filters by providing enhanced down flow effect, and reduced recirculation zones near the bottom of a filter house. Reducing the recirculation zones at the lower intake hoods ensures that settled dust and debris will not recirculate back into the inlet air flow and reenter the air filters.

In one embodiment, an air intake hood extends from a vertical wall of a filter house to channel incoming air flow into the filter house. The intake hood has an inlet for drawing intake air therethrough and an outlet configured to deliver the intake air downward into the filter house. The inlet is disposed in a plane positioned at an inclined angle relative to the vertical wall of the filter house.

In another embodiment, a filter house comprises a plurality of air intake hoods disposed on an exterior vertical wall of the filter house. A plurality of filter elements are disposed on an interior wall of the filter house. The intake hoods each comprise an inlet for drawing intake air therethrough, and an outlet for delivering the intake air into the filter house. The intake hood inlets are positioned at an inclined angle relative to the vertical wall of the filter house.

In yet another embodiment, an air intake hood extends from a vertical wall of a filter house for channeling an incoming air flow downward. The air intake hood comprises an inlet for drawing intake air therethrough, and an outlet configured to be attached to the filter house for delivering the intake air. The intake hood inlet is positioned at an inclined angle.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram of an exemplary filter house having a plurality of intake hoods attached thereto;

FIG. 2 is a diagram of an exemplary intake hood that may be attached to the filter house of FIG. 1; and

FIG. 3 is a diagram of another exemplary intake hood that may be attached to the filter house of FIG. 1.

### DETAILED DESCRIPTION OF THE INVENTION

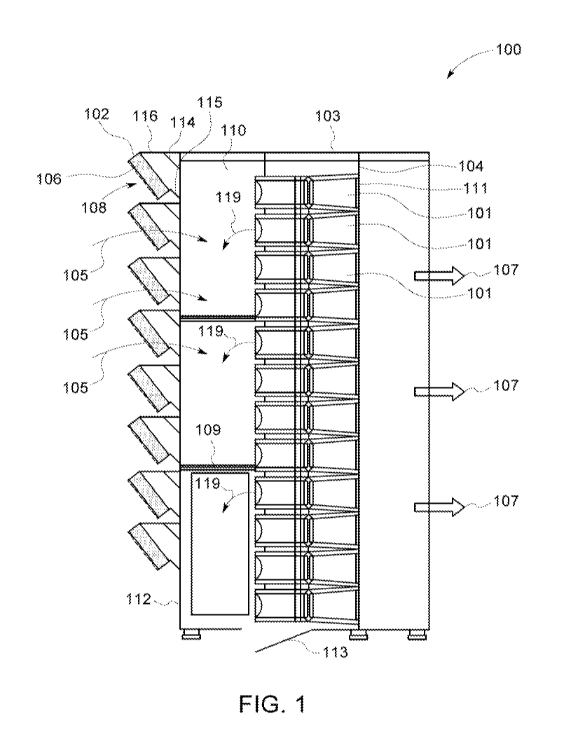

FIG. 1 is a diagram of an exemplary air treatment system 100 that includes multiple intake hoods 102, internal space 110, filters 101, coalescers 106, and a filter house 103 that receives intake airflow 105 and removes moisture and dust therefrom. Inlet air treatment system 100 then directs the filtered exit airflow 107 through downstream ducts. During operation, inlet air treatment system 100 may channel the filtered exit airflow 107 to a gas turbine, such as described above.

Ambient air pressure outside of the intake hoods 102 and dynamic pressure levels within the filter house 103, such as in the downstream air flow 107, determine a differential pressure magnitude across the intake portion of the air treatment system 100. The differential pressure may increase due to intake airflow 105 through the coalescers 106 and the filters 101, which may be caused by dust, dirt or other debris clogging air passages therein.

Inlet air treatment system 100 includes intake hoods 102 that are coupled in flow communication with the filter house 103, such that an intake airflow 105 is defined between an assembly of intake hoods 102 and air filters 101. Intake hoods 102 are vertically-spaced and mounted to an external vertical wall 112 of filter house 103. In an exemplary embodiment, each intake hood 102 includes an intake hood inlet (opening) 108 and a coalescer 106 allowing the intake airflow 105 to enter the filter house 103. In one embodiment, the external vertical wall 112 of the filter house 103 may include a series of support members and openings suitable for attaching the intake hoods 102 thereto. Each coalescer 106 is positioned across the intake hood inlet 108 to facilitate moisture removal from intake airflow 105 entering the air treatment system 100 through intake hood inlet 108. Intake airflow 105 is channeled through intake hood 102, through intake hood inlet 108, and then past intake hood neck 115 and into the filter house 103 toward air filters 101 via internal space 110. Internal space 110 is a region between intake hoods 102 and air filters 101, and may include walkways 109 for maintenance staff to manually access the coalescers 106 and air filters 101.

In one embodiment, filter house 103 includes a tube sheet 104 upon which cartridge-type filter elements 101 are mounted. The filter elements are periodically cleaned using pulsed, pressurized air to dislodge dust and debris from the filter elements 101. The dislodged dust and debris typically falls through the internal space 110 to the bottom of the filter house 103, such as along exemplary descent paths 119 wherein various mechanisms, such as a hinged door 113 and, including but not limited to, manual removal, may be implemented to remove the debris. In an exemplary embodiment, a plurality of access walkways 109 extend between the matrix of filter elements 101 and the intake hoods 102 to provide access to each intake hood 102, the coalescers 106 therein, and to the filters 101. The plurality of filters 101 are each coupled to tube sheet 104 such that each filter 101 fills a corresponding opening 111 in the tube sheet 104 to provide a filtered exit path for airflow 107. In one exemplary embodiment, filters 101 are in flow communication with ambient air entering the inlet air treatment system 100 via the intake hoods 102 and the cleaned exit airflow 107 to the right of the air treatment system 100, as seen in FIG. 1. The gas turbine, located downstream of the filter house 103, provides the suction for drawing the intake airflow 105 into the air treatment system 100 through intake hoods 102, the coalescers 106, and through the air filters 101.

As intake airflow 105 enters intake hoods 102 through coalescers 106, airflow 105 travels through internal space 110 to the filters 101 which remove dust and debris carried by airflow 105. It is preferable that the incoming airflow 105 generates sufficient uniform down flow so that during the periodic pulsed cleaning the dislodged dust and debris is allowed to fall under force of gravity and the down flow of the intake airflow 105 such that the dust and debris settles on the bottom of the filter house 103 for later removal. Disturbances in the air flow, such as turbulence, recirculation zones, upward flow and other non-uniformities in the air velocity, may cause the dislodged dust and debris to be suctioned back into the air filters 101. Ideally, the intake airflow 105 travels with uniform velocity at a downward angle between the intake hoods 102 and the air filters 101.

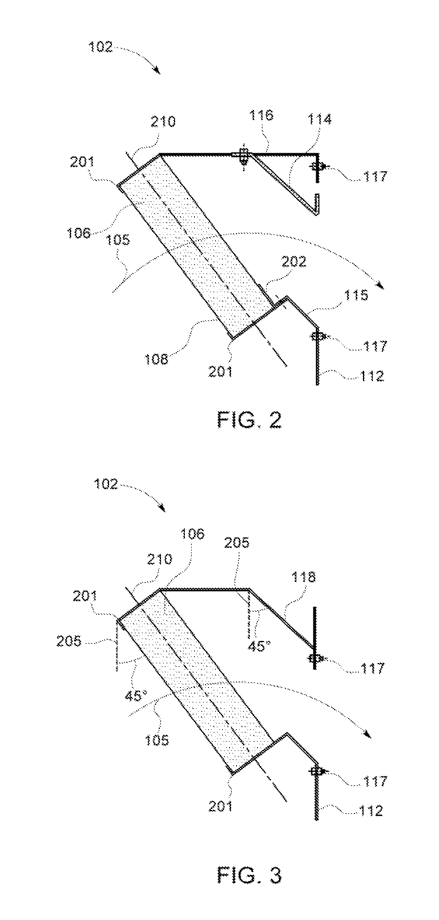

It has been shown that the intake hoods 102 illustrated in FIGS. 1-3 provide improved down flow of the incoming airflow 105 within the interior space 110 which reduces an amount of recirculating air pockets in the interior space 110, regions of air flow disturbance, and pressure drop. FIG. 2 and FIG. 3 are diagrams of exemplary intake hoods 102 that may be used with the inlet air treatment system 100 by attaching a number of the intake hoods 102 on the external vertical wall 112 of the filter house 103. In an exemplary embodiment, inlet air treatment system 100 includes a plurality of intake hoods 102 coupled to an external vertical wall 112 of the filter house 103. Each intake hood 102 may include front bracket members 201 for supporting a coalescer 106 in position across intake hood inlet 108 to remove moisture from the intake airflow 105 passing therethrough, as well an L-shaped back bracket 202 for providing support at a back side of coalescer 106 and preventing collected moisture water from flowing into internal space 110. In the embodiment as shown in FIG. 2, coalescer 106 is in position to substantially cover the intake hood inlet 108, such that an airflow 105 enters through a major frontal surface of coalescer 106. De-moistured intake airflow 105 exits coalescer 106 through a rearward major surface of the coalescer 106 and into the filter house 103.

A major advantage of the intake hood 102 assembly is the inclined or tilted intake hood inlet 108 presented by the intake hood 102. The inclination is represented by the axis 210 of the coalescer 106 which is parallel to a front face of the intake hood inlet 108, which front face may be defined by a plane passing through the top and bottom corners of the intake hood brackets 201. The plane passing through the top and bottom corners of the intake hood brackets 201 may be referred to herein as the intake plane, which is substantially parallel to the axis 210 of the coalescer 106. The front face of the intake hood 102 may be inclined, or tilted, at about 45° from a vertical line 205, which is generally parallel to the external vertical wall 112, as shown in FIG. 3. A top surface 116 of the intake hood 102 may be joined to the filter house 103 external vertical wall 112 by bolts 117 and have a detachable deflector plate 114 attached to the top surface 116 and the external vertical wall 112 of the filter house 103. Alternatively, the top surface 116 of the intake hood 102 may comprise an angled surface 118 (FIG. 3), formed to be integral with the top surface 116 of the intake hood 102, which serves as a deflector, similar to the operation of the deflector plate 114. The deflector plate 114 and the angled surface 118 comprise a preselected angle in relation to the vertical line 205 and serve to deflect incoming air 105 in a generally downward direction. The deflector plate 114 and the angled surface 118 may be positioned at about the same angle as the front face of the intake hood inlet 108, i.e., at about 45° relative to the vertical line 205, and positioned downstream of the intake hood inlet 108. The air intake hood 102 and the deflector 118 or deflector plate 114 does not extend past, or pass through, the plane of the external vertical wall 112 of the filter house 103. Because the incoming airflow 105 is deflected at a smaller angle by the deflector 118 and deflector plate 114 as it enters the filter house 103, as compared with prior art intake hoods, non-uniformity of the airflow 105 is decreased and down flow is improved.

In view of the foregoing, embodiments of the invention reduce non-uniformities in the incoming air flow velocity patterns, reduce overall pressure drop caused by the air filtration system, and improve down flow of the incoming air. A technical effect is to reduce a size of any recirculation zones, lesser maintenance of filter medias, pressure drop savings of about 12.83 pa, and reduced maintenance cycle time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An air intake hood extending from a vertical wall of a filter house for channeling an incoming air flow downward, the air intake hood comprising:
an intake hood inlet for drawing intake air therethrough;
an intake hood outlet configured for delivering the intake air into a filter house,
wherein the intake hood inlet comprises an intake plane positioned at an inclined angle relative to the vertical wall.

2. The air intake hood of claim 1, further comprising a coalescer positioned across the intake hood inlet for removing moisture from the intake air, wherein an axis of the coalescer is parallel with the intake plane.

3. The air intake hood of claim 1, wherein the inclined angle is about forty five degrees.

4. The air intake hood of claim 1, further comprising a deflector positioned downstream of the intake hood inlet for channeling the intake air through the intake hood outlet at a preselected direction.

5. The air intake hood of claim 3, wherein the deflector is positioned at about the inclined angle.

6. The air intake hood of claim 5, wherein the deflector is a detachable deflector.

7. The air intake hood of claim 5, wherein the deflector is formed to be integral with a top surface of the intake hood.

8. A filter house comprising:
a plurality of air intake hoods disposed on an exterior vertical wall of the filter house; and
a plurality of filter elements disposed on an interior wall of the filter house,
wherein the plurality of air intake hoods each comprise:
an intake hood inlet for drawing intake air therethrough;
an intake hood outlet configured for delivering the intake air into the filter house,
wherein the intake hood inlet is positioned at an inclined angle relative to the vertical wall.

9. The filter house of claim 8, wherein the plurality of air intake hoods each further comprise a coalescer positioned across the intake hood inlet for removing moisture from the intake air; and wherein an axis of the coalescer is parallel with the intake hood inlet.

10. The filter house of claim 9, wherein the inclined angle is about forty five degrees.

11. The filter house of claim 8, wherein the plurality of air intake hoods each further comprise a deflector positioned downstream of the intake hood inlet for channeling the intake air through the intake hood outlet at a preselected direction.

12. The filter house of claim 11, wherein the deflector is positioned at an inclined angle relative to the vertical wall.

13. The filter house of claim 11, wherein the deflector comprises bolts for detachably attaching the deflector from the intake hood.

14. The filter house of claim 8, wherein the intake hood and the deflector are positioned such that they do not extend past a plane comprising the external vertical wall and into the filter house.

15. An air intake hood extending from a vertical wall of a filter house for channeling an incoming air flow downward, the air intake hood comprising:
an intake hood inlet for drawing intake air therethrough; and
an intake hood outlet configured to be attached to a filter house for delivering the intake air,
wherein the intake hood inlet is positioned at an inclined angle.

16. The air intake hood of claim 15, further comprising a coalescer positioned across the intake hood inlet for removing moisture from the intake air, wherein the coalescer is positioned across the intake hood inlet and an axis of the coalescer is parallel with the intake hood inlet.

17. The air intake hood of claim 15, wherein the inclined angle is about forty five degrees as measured from an external vertical wall of the filter house.

18. The air intake hood of claim 15, further comprising a deflector positioned downstream of the intake hood inlet for channeling the intake air through the intake hood outlet at a preselected direction.

19. The air intake hood of claim 18, wherein the deflector is positioned at an inclined angle of about forty five degrees as measured from the external vertical wall of the filter house.

20. The air intake hood of claim 18, wherein the intake hood and the deflector are positioned such that they do not extend past a plane of the exterior vertical wall into the filter house.
